(19) United States
(12) Patent Application Publication
(10) Pub. No.: US 2005/0114998 A1
(43) Pub. Date: Jun. 2, 2005

(54) Inflatable bedrest

(75) Inventors: Robert Leventhal, Los Angeles, CA (US); Paul Thomas, San Pedro, CA (US); Edmund Scott Davis, Ft. Lauderdale, FL (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Banyan Licensing LC

(21) Appl. No.: 10/937,233

(22) Filed: Sep. 9, 2004

Related U.S. Application Data
(63) Continuation-in-part of application No. 10/459,037, filed on Jun. 11, 2003, now abandoned.
Application No. 10/459,037 is a continuation-in-part of application No. 10/116,230, filed on Apr. 4, 2002, now Pat. No. 6,681,425.
(60) Provisional application No. 60/587,171, filed on Jul. 12, 2004.

(51) Int. Cl. A61G 7/015

(52) U.S. Cl. 5/615

(57) ABSTRACT

An inflatable bedrest which is composed of a bladder which when inflated defines three longitudinally extending side walls disposed in a triangular configuration. To support the bladder in the desired triangular configuration, there is provided an interior baffle mounted within the bladder which in one embodiment comprises a pair of longitudinally extending panels disposed in a V-shaped arrangement and joined to the side walls. In another embodiment, one or more transverse panels form the baffle, either alone or in conjunction with the V-shaped panels. The bedrest may be used to form an assembly which may be assembled to the head end portion of a bed mattress and serves to adjustably lift the head end portion.

### CROSS-REFERENCE TO RELATED APPLICATIONS

This application is a continuation-in-part of co-pending U.S. patent application Ser. No. 10/459,037 filed on Jul. 11, 2003, which is a continuation-in-part of U.S. Pat. No. 6,681,425 which issued on Jan. 27, 2004 and provisional Application Ser. No. 60/587,171 filed on Jul. 12, 2004 each of which is hereby incorporated herein in their entirety by reference.

### BACKGROUND OF THE INVENTION

1. Field of the Invention

The present invention generally relates to an inflatable bedrest of triangular configuration and which is adapted to be positioned upon one end of a bed. More specifically, an inflatable bedrest that includes a cover.

2. Description of Related Art

Adjustable beds have found widespread use beyond nonambulatory patients and are used in many homes among persons of all age groups, in particular beds that raise the head and/or feet. Among the devices used to raise the head or feet are inflatable air bladders intended for use with conventional beds. A number of patents disclose bladders for this purpose. For example, U.S. Pat. Nos. 3,392,412 and 3,606,623 to Aymer provide a bedrest having an inflatable bellows placed under a mattress and filled with compressed air. The bladder is filled with air by a conventional electric motor which is activated by a switch to turn the motor on and off. One problem with such devices is that when the bladders are inflated, the mattress will occasionally slide out of position on the bladder due to the combination of gravity and the low coefficient of friction of the material used to make the bladder.

A number of patents are directed to maintaining the position of a mattress on a bed, but they typically use brackets and are more complex and more cumbersome than the invention disclosed herein. For example, U.S. Pat. No. 4,297,754 and U.S. Pat. No. 4,017,919 each disclose a plurality of mattress retention brackets associated with a bed. In each of these inventions, the mattress is supported upon box springs, and the mattress retention brackets prevent each mattress from shifting relative to its associated box spring.

Similarly, U.S. Pat. No. 5,978,992 to Antinori discloses a mattress retention bracket for an adjustable bed to prevent an associated mattress from sliding laterally thereon. The mattress retention bracket is a generally U-shaped member defined by a loop portion and a pair of legs with each leg having first and second end portions normally offset from each other.

Another adjustable bed rest is shown in U.S. Pat. No. 3,667,075 which discloses a bellows assembly placed under the mattress wherein the mattress is raised either at the head section or under the knee to different heights through the expandable bellows. The bellows assembly is activated by a motor containing three position switches that are manually turned upwardly to actuate respective spool valves. When the switches are turned downwardly, they operate respective solenoid valves.

The Cammack patent, U.S. Pat. No. 4,309,783, discloses an inflatable bladder that is triangular in shape. The bladder in Cammack includes flexible elements which extend from adjacent the apex to adjacent a sidewall of the triangle designed to limit the expansion of the bladder. These flexible elements of specific length are designed to reinforce maintenance of the general shape of the bag in its generally triangular shape. The control mechanism has two double acting rocker buttons associated respectively with valve outlets. Upon depression of a rocker button in one direction, the motor is energized at the same time that the valve outlet is opened, allowing air to be delivered to the air bag through a hose. The same rocker button rocked in the opposite direction enables air to be removed from the bag.

U.S. Pat. No. 5,170,522 to Walker discloses a foundation that has a first open top housing or recess located below a backrest plate. A first lift air bag is located in a first recess. When expanded, the first air bag has a generally triangular configuration so as to elevate the backrest plate in a generally upward inclined position. A second air lift bag is located adjacent the leg portion of the structure. When expanded, this has a generally trapezoidal configuration. An air mattress is located on top of the foundation and the air mattress is adapted to bend with the transverse plates when the plates are elevated with the first and second lift air bags. A hand control is used to control the operation of a pump to change the air pressure in the mattress and also to change the air pressure in the first and second lift air bags. The controller has air operated switches for regulating a pump to supply air to air mattresses and lift air bags. Switches also control separate solenoid valves that are used to direct to the air mattress and lift bags.

U.S. Pat. No. 6,739,005 to Davis discloses an air adjustable mattress having a plurality of sections and an air chamber under each section that is to be raised. The contour and shape of the mattress is controlled by inflating and deflating each air chamber to elevate and incline the section of the mattress. The sections are connected together by fastener means. Because of the hinged construction of the mattress, the mattress does not tend to move from its original position when the air chamber is inflated.

It is an object of the present invention to provide a bedrest that includes a triangular-shaped bladder when inflated.

Another object of the invention to provide an easy, effective, and inexpensive way to maintain constant the position of a mattress relative to an inflatable bladder while the mattress is resting on the inflatable bladder by connecting the bladder to the mattress.

A further object of the present invention to provide a device for raising and lowering the head end and/or the foot end of a mattress that includes a triangular shaped inflatable bladder and a hand held microprocessor controller.

Yet another object of the invention to provide an inflatable assembly which can be assembled to an end portion of a bed mattress and which is adapted for lifting the one end portion of the bed mattress.

A further object of the present invention is to provide an adjustable bedrest that includes an inflatable bladder having a cover and connected to a mattress cover.

### SUMMARY OF THE INVENTION

The above and other objects and advantages of the invention are achieved by the provision of a bed support which comprises a bladder fabricated of a flexible air impermeable sheet material which when inflated defines three longitudinally extending side walls disposed in a triangular configuration when viewed in transverse cross section. Opposite end walls close the ends of the bladder. The inflatable bladder may be trapezoidal shaped but is preferably triangular shaped with one side of the bladder cover being attached to the underside of the mattress cover. Also, the bladder includes interior baffle means for supporting the bladder in the triangular configuration when inflated, and in one embodiment the baffle means comprises a pair of longitudinally extending panels disposed in a V-shaped arrangement with each panel being joined to the interior of two adjacent side walls of the bladder.

In another embodiment, the baffle means comprises at least one transverse panel positioned within the bladder and joined to the interior of at least two of the side walls. In still another embodiment, the baffle means comprises both the V-shaped panels and the transverse panel, both as described above.

The bed support also includes an air delivery system which includes an opening communicating with the interior of the bladder.

The benefit of the interior baffle means is that once the bladder is inflated, the baffle means will cause the bladder to form into an appropriate triangular shape. Without this baffle means, even though the overall structure of the bladder is intended to be triangular when it is inflated, the shape cannot be as precisely controlled without the baffle means and the resultant bladder may form into a circle or an oblong shaped object of non-triangular shape. The interior baffle means therefore enables the structure to form more precisely into the desired triangular shape in order to perform more effectively when positioned upon or inserted under the mattress at the head location of the bed.

As a further aspect of the invention, the bed support as described above may be used as part of an inflatable assembly for being joined to and adjustably lifting one end portion of a bed mattress. In this configuration, the bladder is closely received in a fabric casing, and a tubular fabric cover is provided which is configured to slip over and encase the one end portion of the bed mattress. The cover is sized to overlie an upwardly inclined side wall of the bladder, and the cover is secured to the casing so as to prevent relative movement therebetween.

In another embodiment, there is provided a means for attaching the cover of the inflatable bladder to the underside of the mattress. In general, any means of attaching two covers can be used. Specifically, the means for joining the covers together can be a zipper, a hook and fastener apparatus, or sewing the covers together. Velcro® is a hook and fastener that is particularly effective in joining the mattress and the air bladder. Snaps and other fasteners can also be used.

An important aspect of the invention is that the air bladder and the mattress stay joined together even after the bladder is inflated. The user can inflate and deflate the bladder as needed without worrying about whether the two sections will keep together.

A microprocessor based hand controller enables an individual to inflate or deflate either the bladder under the head area or the bladder under the knee area of the bed to any desired amount with a simple control. In addition, the hand controlled microprocessor permits computer programming so that the mattress can be automatically raised and lowered to different levels during different periods of time. An additional feature is that one does not need to simply continue to hold the switch down in order to raise or lower the bladder portion but instead can press a simple button after the entire hand controlled microprocessor has been preprogrammed so that any one of a number of different adjustments can be made and these can be made at any given time and preset to any given time and interval.

Thus, with the present invention there is provided a bed support for raising and lowering the head and/or leg area of a bed that is easy to install, simple in operation, and may be used with a conventional bed.

### BRIEF DESCRIPTION OF THE DRAWINGS

Having thus described the invention in general terms, reference will now be made to the accompanying drawings, which are schematic in nature and not necessarily drawn to scale, and wherein:

FIG. 1 is a perspective view of an adjustable bed showing a bed support of the invention at the head of the bed in an elevated position, and also showing a second bed support positioned to underlie the knees of a user;

FIG. 2 is a perspective view of the triangular shaped bladder of the present invention with the near end wall removed;

FIG. 3 is a cross sectional view of the triangular shaped bladder taken along line 3-3 of FIG. 2;

FIG. 4 is a perspective view, with part of one side wall broken away, as of a second embodiment of the bladder;

FIG. 5 is a perspective view, with part of one side wall broken away, of a further embodiment of the bladder;

FIG. 6 is a sectional view taken along the line 6-6 of FIG. 5;

FIG. 7 is a fragmentary perspective view of the head end portion of a bed having an assembly which includes the bladder of the present invention joined to and underlying the end portion of the mattress;

FIG. 8 is a sectional view taken along the line 8-8 of FIG. 7;

FIG. 9 is a view similar to FIG. 8 but also illustrating the use of a reinforcing panel;

FIG. 10 is a perspective of another embodiment of the bedrest of the present invention showing a mattress having a cover surrounding the mattress and an air bladder having a cover surrounding the air bladder;

FIG. 11 is a perspective view looking upward showing an embodiment of the bladder of the present invention having a cover and a zipper for attaching the bladder cover to the underside of a mattress cover;

FIG. 12 is a view similar to FIG. 11 and shows the bladder cover removed from the underside of the mattress cover;

FIG. 13 shows another embodiment of the present invention wherein the bladder cover is attached to the underside of the mattress cover using a Velcro® fastener; and

FIG. 14 shows yet another embodiment of the present invention wherein the bladder cover is sewn to the underside of the mattress cover.

### DETAILED DESCRIPTION OF THE INVENTION

The present invention now will be described more filly hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

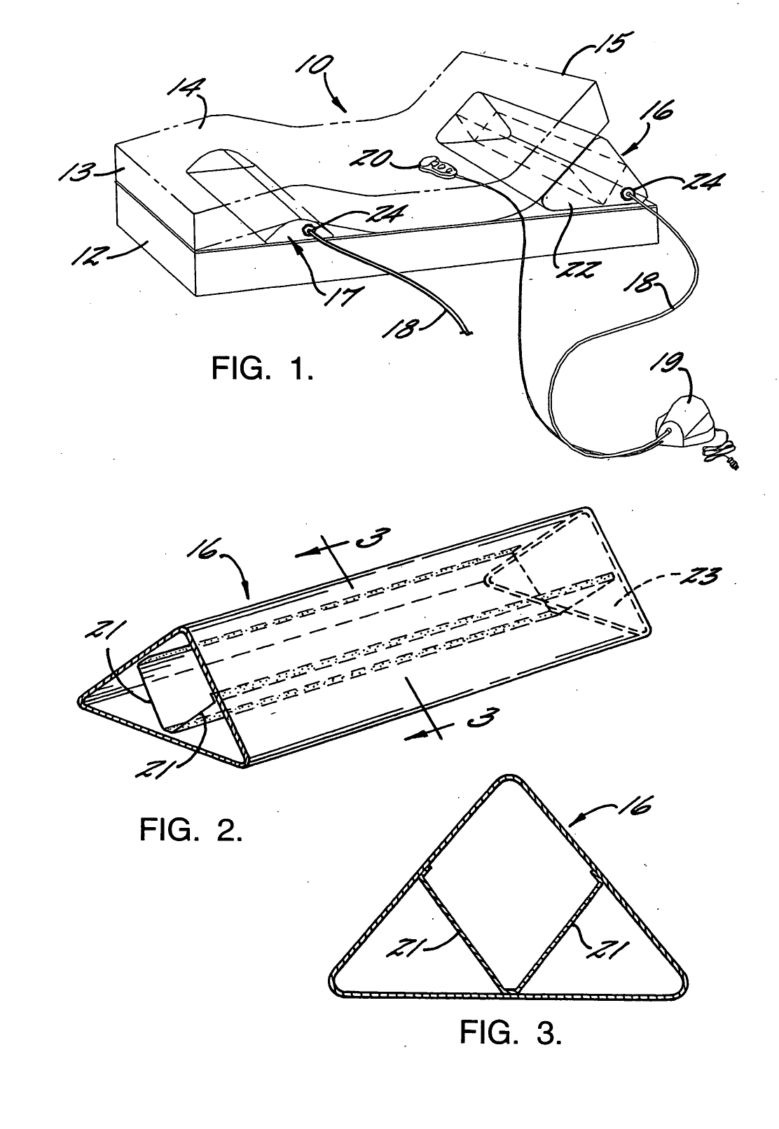

Referring more particularly to the drawings, FIG. 1 shows a bed 10 for use with the present invention. The bed 10 is generally rectangular and has conventional box springs or other suitable foundation 12, and a mattress 14. In other words, the bed used with the present invention may be a conventional bed. The mattress 14 has a head/back portion 15 and a leg/foot portion 13.

An inflatable bed support 16 having an air supply tube 18 for inflating and deflating the bed support is provided for raising and lowering the head portion 15 of the mattress. As shown in FIG. 1 there is also provided a second inflatable bed support 17 placed to underlie the knees of the user. It should be understood that the two bed supports 16 and 17 may be placed under the mattress 14 as illustrated, or upon the mattress. Also, the bed supports 16 and 17 are of like configuration as further described below, but with the support 16 being larger than the support 17.

As shown more clearly in FIGS. 2 and 3, the bed support 16 includes a bladder, which is a triangular shaped structure when inflated and contains an interior baffle 21. More particularly, the bladder comprises a flexible air impermeable sheet material which when inflated defines three longitudinally extending side walls disposed in a triangular configuration when viewed in transverse cross section, note FIG. 3. The bladder is closed by opposite end walls 22, 23 to form a hermetically closed chamber.

An air delivery system is provided for delivering pressurized air into the interior of each bed support 16 and 17. The air delivery system includes an opening 24 in the end wall 22 of the bladder, and which is connected via an air supply tube 18 to an air pump motor 19 that is controlled by hand held control switch 20. For purposes of the present invention, the air pump motor 19 and control switch 20 may be of conventional design. In a preferred embodiment however, the pump and switch as described in copending U.S. application Ser. No. 10/116,230 filed Apr. 4, 2002 may be employed. The disclosure of the referenced copending application is expressly incorporated herein by reference.

The interior baffle 21 is mounted within the bladder for supporting the bladder in the triangular configuration when inflated. The baffle 21 comprises a pair of longitudinally extending panels which are disposed in a V-shaped arrangement when viewed in cross section (note FIG. 3), with each panel joined to the interior of two adjacent side walls of the bladder.

The panels of the baffle 21 have a longitudinal length which is slightly shorter than the longitudinal length of the side walls of the bladder 16, so as to be spaced from the end walls 22, 23 and thereby permit air flow around both ends of the baffle within the bladder.

The benefit of this interior bladder is that once the bladder is inflated, the baffle will cause the bladder to form into an appropriate triangular shape. Without this baffle, even though the overall structure of the device is intended to be triangular when it is inflated, the shape cannot be as precisely controlled without the baffle and the resultant bladder will form into possibly a circle or an oblong shaped object of non-triangular shape. The interior baffle therefore enables the structure to form more precisely into the desired triangular shape in order to perform a more effective lifting when inserted under the mattress.

The bladder and the panels of the baffle may be fabricated of a variety of flexible air impermeable sheet materials, such as the plastic sheet materials commonly used in the construction of swimming pool toys. Such materials also facilitate the fabrication of the bladder, since the sides may be heat sealed to the ends of the bladder and to the panels of the baffle 21. Furthermore, the dimensions of the inflatable bladder may vary depending upon the size of the bed intended to be elevated. Preferably, however, the inflatable bed support is of a longitudinal length approximate the width of the bed on which it is used.

FIG. 4 illustrates a second embodiment of the bed support of the present invention at 16a. In this embodiment, the baffle includes a transverse panel 25a positioned within the bladder and joined to the interior of at least two, and preferably all three of the side walls, by a heat seal or the like. Also, in the illustrated embodiment, the panel 25a is located at a medial location along the longitudinal length of the bladder to divide the interior into two chambers of substantially equal size. Further, by heat sealing the panel 25a to all three walls of the bladder, the two chambers will be hermetically sealed from each other. This improves the stability of the bed support for the user, particularly in the case of a double bed where the weight is not uniformly distributed along the length of the support.

Where the two chambers are hermetically sealed from each other, the air delivery system comprises separate openings 24a communicating with each of the chambers through one of the side walls of the bladder.

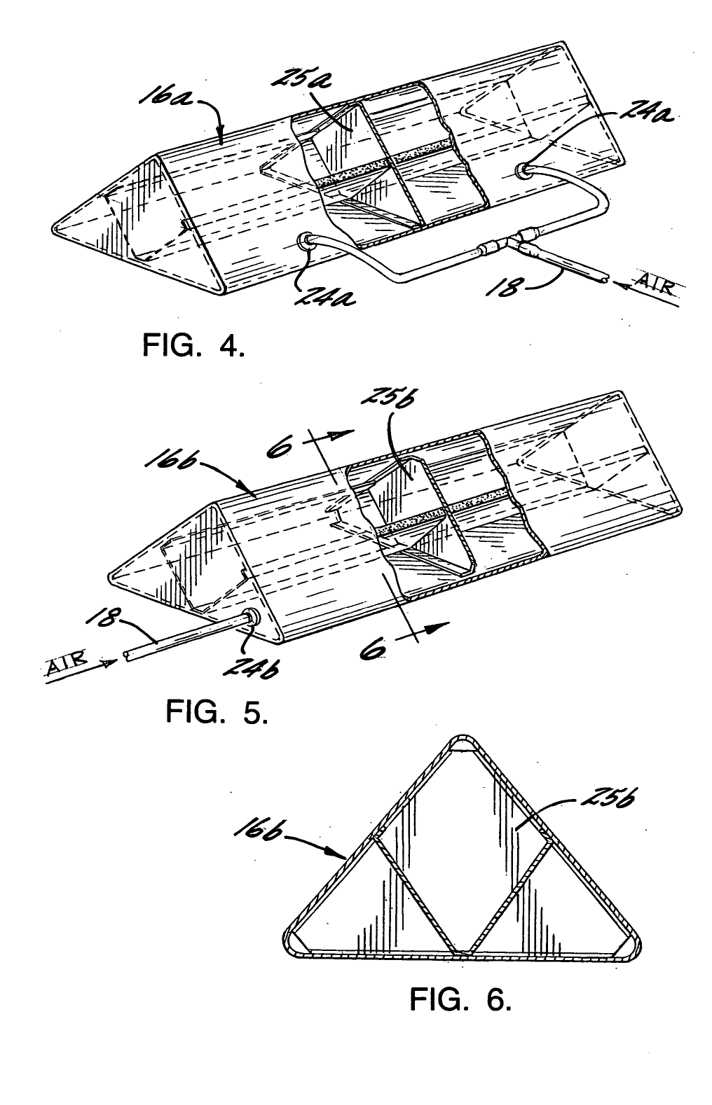

FIG. 5 shows an embodiment at 16b similar to that of FIG. 4, but where the panel 25b is not sealed about the entire periphery to the side walls of the bladder. Specifically, and as seen in FIG. 6, the corners of the panel 25b are separated from the bladder side walls to form passages. Thus only one air opening 24b is required, and the air is free to flow between the chambers at a slow or restricted rate. As an alternative to the open corners, the panel 25b may have one or more small openings (not shown) therethrough which permit restricted air flow between the chambers.

While a single transverse panel is illustrated in FIGS. 4 and 5, it will be appreciated that more than one panel may be employed, particularly in the case of bed supports sized to fit mattresses of double bed or larger size.

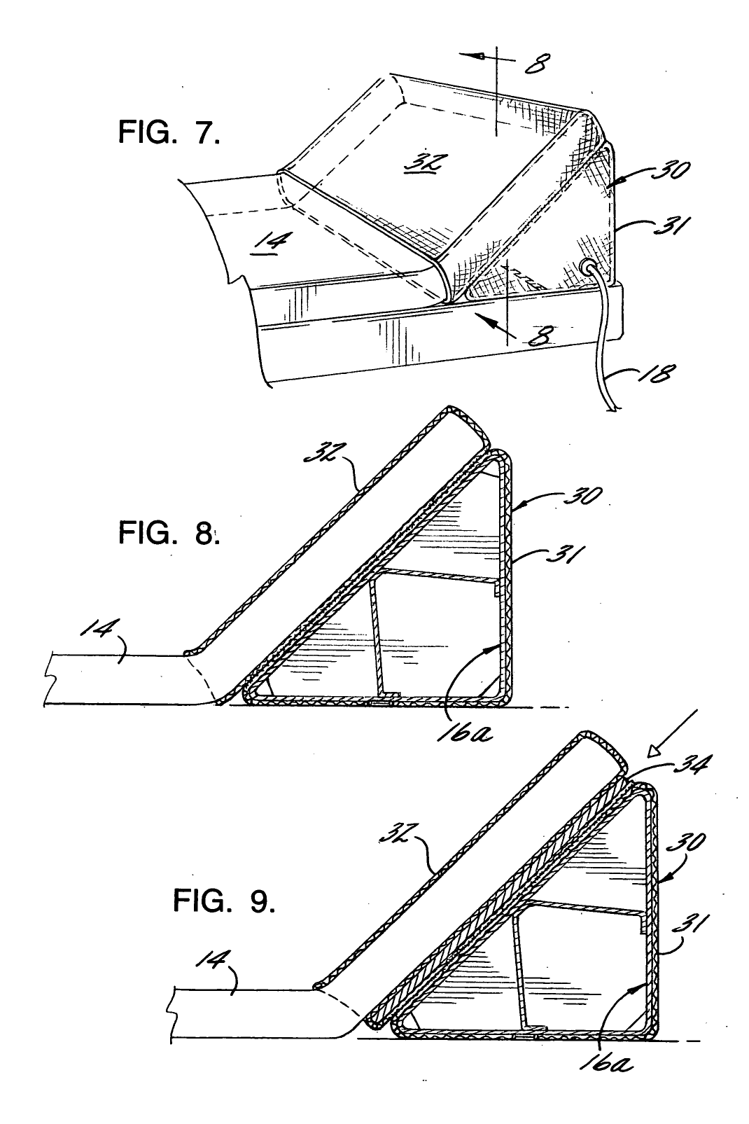

FIGS. 7-9 illustrate further embodiments of the invention and wherein the bed support 16 forms part of an assembly 30 for adjustably lifting one end portion of a bed mattress. In the illustrated embodiment, the assembly 30 comprises a bed support 16a as described above, but which is configured to form a right triangle rather than an isosceles triangle as in the embodiments of FIGS. 1-6. The bed support 16a is received in a fabric casing 31 which is sized to closely encase the bed support 16a when it is fully inflated. Also, there is provided a tubular fabric cover 32 which is configured to slip over and encase the head end portion of the mattress 14. The cover 32 is sized to overlie an upwardly inclined side wall of the bladder of the support 16a, and the cover 32 is secured to the casing 31 so as to prevent relative movement therebetween.

The cover 32 may be secured to the casing 31 by stitching or the like, and in a preferred embodiment the stitching forms a pocket which is open at the upper end so as to be adapted to receive a reinforcing relatively rigid flat plate 34 so as to be positioned between the casing 31 and cover 32 and overlie the upwardly inclined side wall of the bladder and reinforce the same.

The illustrated embodiment of the cover 32 includes a closed upper end which overlies the end of the mattress, but it will be understood that the cover may take the form of a sleeve with both ends being open. Also, it will be understood that the casing 31 may include suitable zippers or Velcro® closures (not shown) to permit the cover to be removed from the bladder for periodic cleaning.

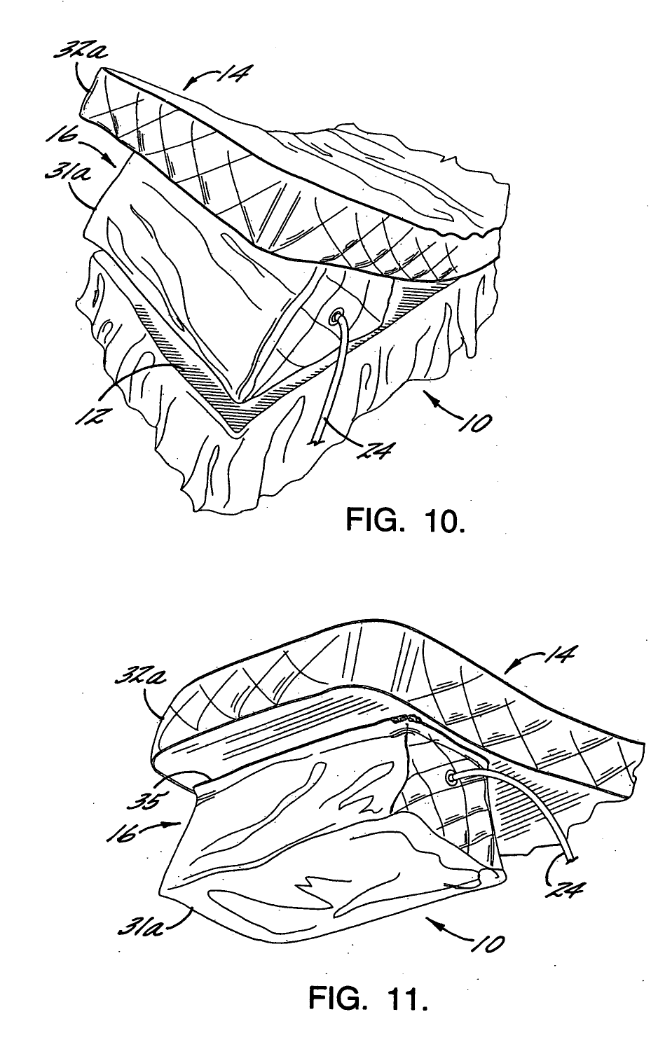

In a preferred embodiment, the bedrest 10 comprises a foundation 12 such as a box springs, as shown in FIG. 10. It should be understood that the foundation can be any surface upon which a mattress can lie. In this embodiment, the inflatable bladder shown inside cover 16 lies on the box springs 12, and the mattress 14 is inside mattress cover 32a lies on top of the inflatable air bladder, as shown in FIG. 10. A preferred air bladder is disclosed in U.S. Pat. No. 6,715,172, which is herein incorporated by reference. The bladder 16 inside cover 31a is inflated and deflated with compressed air through hose 24.

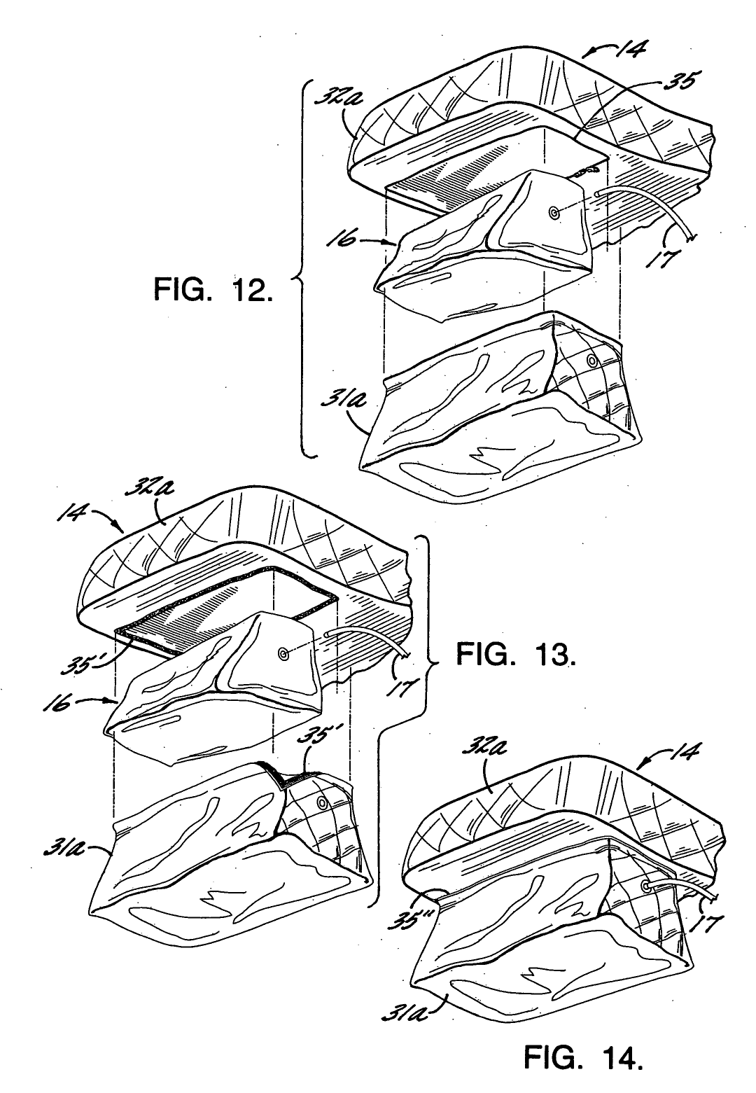

FIGS. 11 and 12 show more clearly the embodiment of the invention wherein the mattress cover 14 and the bladder cover 31a are joined using a zipper 35. The user need only join the zipper portions and pull the zipper handle in order to connect the air bladder cover 31a and the mattress cover 14. As shown in FIG. 12, the inflatable air bladder 16 may be placed inside air bladder cover 31a and connected to the air hose 17 through a hole in cover 31a. The air bladder 16 can be inflated before, during, or after the air bladder and mattress are connected, but once they are connected a unitary article is formed.

To practice the method of the invention, the air bladder inside cover 31a and the mattress cover 32a are brought within close proximity of each other, with each part having one portion of the zipper. The female and male parts of the zipper are joined, and when the handle is pulled, the teeth of the opposing portions of the zipper interlock, thereby connecting the mattress and the air bladder. Once the two parts of the zipper are attached, the air bladder can be inflated as desired.

The means for joining the mattress cover 32a and the bladder cover 31a can be a hook and fastener apparatus, such as a Velcro® fastener 35′. In the embodiment shown in FIG. 13, a strip of Velcro® fastener having hooks is attached to the air bladder cover 31a, and a strip of Velcro® having fasteners is attached to the mattress cover 32a. The air bladder and the mattress instantly join when the hooks and fasteners are directly opposed and are touching each other.

In another alternative embodiment, that of FIG. 14, the bladder cover 31a is sewn 35″ to the underside of the mattress cover 32a. In this particular embodiment, the thread is tightly stitched between the air bladder and the mattress so that the two covers are connected.

As shown in the drawings of this application, the mattress and the inflatable air bladder each have covers which in the preferred embodiment are cloth. It should be understood, however, that the mattress cover, for example, might be cloth having a Velcro® fastener on its underside and the bladder might not have a cover but simply have the other half of the Velcro® fastener means attached to one of the sides of the bladder that comes into contact with the underside of the mattress and be connected together in that manner.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. An inflatable bedrest, comprising:
an inflatable bladder comprising a flexible air impermeable sheet material which when inflated defines three longitudinally extending side walls disposed in a triangular configuration when viewed in transverse cross section, and two opposite end walls which are transverse to said side walls,
interior baffles comprising a pair of longitudinally extending panels which are disposed in a V-shaped arrangement when viewed in transverse cross section mounted within the bladder for supporting the bladder in said triangular configuration when the bladder is inflated, said baffle means comprising at least one panel joined between the interior of two adjacent side walls of the bladder, and
an air delivery system comprising an opening communicating with the interior of the bladder.

2. The inflatable bedrest as defined in claim 1 wherein said baffle means further comprises at least one transverse panel positioned within said bladder and joined to the interior of at least two of the side walls.

3. The inflatable bedrest as defined in claim 2 wherein the one transverse panel is located at a medial location along the longitudinal length of the bladder to divide the interior into two chambers of substantially equal size.

4. The inflatable bedrest as defined in claim 3 wherein the one transverse panel is joined to the interior of the three side walls of the bladder so as to hermetically seal the two chambers from each other, and wherein the air delivery system comprises separate openings communicating with each of the chambers.

5. The inflatable bedrest as defined in claim 2 wherein the one transverse panel is joined to the interior of the side walls or includes one or more openings therethrough so as to permit the passage of air between the two chambers at a restricted flow rate, and wherein the air delivery system comprises a single opening communicating with one of the chambers.

6. The inflatable bedrest as defined in claim 1 wherein said baffle means comprises at least one transverse panel positioned within said bladder and joined to the interior of at least two of the side walls.

7. The inflatable bedrest as defined in claim 6 wherein said one transverse panel is located at a medial location along the longitudinal length of the bladder to divide the interior into two chambers of substantially equal size.

8. The inflatable bedrest as defined in claim 4 wherein said one transverse panel is joined to the interior of the three side walls of the bladder so as to hermetically seal the two chambers from each other, and wherein the air delivery system comprises separate openings communicating with each of the chambers.

9. The inflatable bedrest as defined in claim 4 wherein said one transverse panel is joined to the interior of the side walls or includes one or more openings therethrough so as to permit the passage of air between the two chambers at a restricted flow rate, and wherein the air delivery system comprises a single opening communicating with one of the chambers.

10. The inflatable bedrest as defined in claim 1 further comprising a tubular cover configured to slip over and encase one end portion of a bed mattress and being sized to overlie one of said side walls of said bladder, and a casing which is joined to the casing and which closely encloses the bladder when it is inflated, and wherein the bed support may be positioned so that the casing and enclosed bladder underlie and lift one end portion of the bed mattress.

11. An inflatable assembly for adjustably lifting one end portion of a bed mattress, comprising
an inflatable bladder comprising a flexible air impermeable sheet material which when inflated defines three longitudinally extending side walls disposed in a triangular configuration when viewed in transverse cross section, with said side walls including a base side wall and an upwardly inclined side wall,
interior baffle means mounted within the bladder for supporting the bladder in said triangular configuration when the bladder is inflated,
an air delivery system comprising an opening communicating with the interior of the bladder,
a casing sized to closely receive the bladder when inflated, and
a tubular cover configured to slip over and encase the one end portion of a bed mattress and being sized to overlie said upwardly inclined side wall of said bladder, with said cover being secured to the casing so as to prevent relative movement therebetween.

12. The inflatable assembly as defined in claim 11, wherein said baffle means comprises a pair of longitudinally extending panels which are disposed in a V-shaped arrangement when viewed in transverse cross section, with each panel being joined to the interior of two adjacent side wall of the bladder.

13. The inflatable assembly as defined in claim 12, wherein said baffle means further comprises at least one transverse panel positioned within said bladder and joined to the interior of at least two of the side walls.

14. The inflatable assembly as defined in claim 11, wherein said baffle means comprises at least one transverse panel positioned within said bladder and joined to the interior of at least two of the side walls.

15. The inflatable assembly as defined in claim 11 further comprising a relatively rigid plate positioned between said casing and said cover so as to overlie said upwardly inclined side wall and further support the same.

16. An assembly including an inflatable bladder which is configured for adjustably lifting one end portion of a bed mattress, said assembly comprising
a casing sized to closely enclose the bladder when inflated, and
a tubular cover configured to slip over and encase the one end portion of a bed mattress, and with said cover being secured to the casing so as to prevent relative movement therebetween.

17. The assembly as defined in claim 16 further comprising means to rigidify the inclined side wall of the casing and support the same in a generally flat configuration.

18. The assembly as defined in claim 17 wherein the means to rigidify the inclined side wall of the casing comprises a relatively rigid plate positioned between the casing and the cover.

19. An inflatable bedrest comprising:
a mattress having a mattress cover;
an inflatable air bladder having a cover; and
a means for joining the air bladder cover to the mattress cover.

20. The inflatable bedrest according to claim 19 wherein at least one of said covers is made from cloth.

21. The inflatable bedrest of claim 19 wherein said means for joining is a zipper.

22. The inflatable bedrest of claim 19 wherein said means for joining is to sew the inflatable bladder cover to the underside of the mattress cover.

23. The inflatable bedrest of claim 22 wherein said means for joining is a Velcro® fastener.
